(19) United States
(12) Patent Application Publication
(10) Pub. No.: US 2003/0060084 A1
(43) Pub. Date: Mar. 27, 2003

(54) Connector

(75) Inventor: Hiroshi Aoki, Shizuoka (JP)

Correspondence Address: SUGHRUE MION, PLLC, 2100 PENNSYLVANIA AVENUE, N.W., WASHINGTON, DC, 20037, US

(73) Assignee: YAZAKI CORPORATION

(21) Appl. No.: 10/243,772

(22) Filed: Sep. 16, 2002

(30) Foreign Application Priority Data
Sep. 21, 2001 (JP) P2001-289484

(51) Int. Cl. H01R 9/03

(52) U.S. Cl. 439/610

(57) ABSTRACT

Three wires, forming a cable, are arranged as a set, and within a connector (1), connection terminals (11), secured respectively to end portions of the wires (5), are arranged in a triangular form analogous to an initial form of arrangement of the wires (5).

### BACKGROUND OF THE INVENTION

This invention relates to a connector suitably connected, for example, to an image transmission cable or the like for effecting the high-speed differential transmission.

In recent years, for example, with the improved resolution of liquid crystals, the image transmission has been carried out at high speed.

One example of EMI-resistant electrical connectors, which enable the high-speed transmission, and are resistant to electromagnetic interference in order to meet the above requirement, is disclosed in JP-A-6-5329.

In one such connector 101 shown in FIG. 6, a plurality of wires 105, jointly forming a cable 103, are connected to respective terminals in a connector member 107 by soldering or press-contacting. An end portion of a shielding conductor 106, surrounding the wires 105, is press-fastened by a metal clamp 108. Shell terminals 109U and 109L, jointly forming a connector shell, are fitted on the connector member 107 respectively from upper and lower sides thereof. The metal clamp 108 is contacted with the shell terminals 109U and 109L, and therefore is electrically connected thereto. An outer housing (not shown) or the like, made of a resin material, is fitted on the shell terminals 109U and 109L to cover them.

In a connector 111 shown in FIG. 7, a plurality of wires 115, jointly forming a cable 113, are connected to respective terminals in a connector member 117 by soldering or press-contacting. When upper and lower shells 119U and 119L, jointly forming a connector shell, are fastened together by pressing, the connector shell is contacted with a shielding conductor 114, and covers the connector member 117.

In these connectors 101 and 111, in order to match the differential impedance between the wires, the terminal arrangement structure is formed into a microstripline structure.

In the above conventional connectors, however, when the wires 105, 115 are to be connected to the respective terminals, the wires 105, 115 are raveled and spread in accordance with the pitch of the strip lines and the number of poles of the connector, and therefore there is a fear that the impedance mismatching occurs. As a result, there is encountered a problem that a current loss of the connector increases. And besides, the impedance and the size of the connector are determined by the pitch and the thickness and width of copper foils of the microstrip lines, and therefore there is encountered a problem that the size of the connector increases in proportion to the number of the poles.

### SUMMARY OF THE INVENTION

This invention has been made under the above circumstances, and an object of the invention is to provide a connector which achieves the enhanced impedance matching, and is suited for high-speed transmission.

In order to solve the aforesaid object, the invention is characterized by having the following arrangement.

(1) A connector comprising:

connection terminals to which a cable including a wire group having three wires arranged in a triangular form is connected, the connection terminals are secured to end portions of the wires, respectively, wherein the connection terminals are arranged in a triangular form, analogous to a form of arrangement of the three wires in order to achieve the impedance matching between the connector and the cable.

(2) The connector according to (1), wherein each of the connection terminals arranged in the triangular form is secured to the end portion of the corresponding one of the three wires disposed nearest to it.

(3) The connector according to (1), wherein the connector includes:

an inner housing for receiving the connection terminals connected respectively to the wires by press-fastening;

an shell terminal mounted on the inner housing to cover an outer peripheral surface of the inner housing;

an outer housing in which the inner housing and the shell terminal are fitted;

a sleeve for holding the shell terminal in contact with a shielding conductor of the cable exposed at a distal end portion of the cable to be connected to the connection terminals; and

a rear holder connected to the outer housing to cover a rear end portion of the shell terminal projecting outwardly from the outer housing.

(4). The connector according to (3), wherein

the rear end portion of the shell terminal is formed into a lid structure which can be opened and closed,

when the lid structure is in an open condition, the inner housing can be inserted into the shell terminal, and

when the lid structure is in a closed condition, the shell terminal is held in contact with the shielding conductor in surrounding relation to a rear end portion of the inner housing.

According to the above structure, the connection terminals, secured respectively to the end portions of the three wires, are arranged in the triangular form, analogous to the form of arrangement of the three wires, and therefore in contrast with the conventional connector, the wires do not need to be much raveled when securing the connection terminals to the respective wires. Therefore, the impedance matching in the connector can be enhanced.

According to the above structure, the length of the area of connection between the connection terminal and the wire can be reduced, and even when the impedance matching is not completely achieved, the attenuation can be kept to a minimum.

According to the above structure, the shell terminal covers not only the outer peripheral surface of the inner housing but also the rear end portion thereof in surrounding relation thereto, and therefore external noises can be completely shut off.

### BRIEF DESCRIPTION OF THE DRAWINGS

FIG. 1 is a perspective view showing the appearance of one preferred embodiment of a connector of the present invention.

FIG. 2 is an exploded, perspective view of the connector of FIG. 1.

FIG. 3 is a front-elevational view of the connector as seen from a direction III of FIG. 1.

FIG. 4 is a cross-sectional view taken along the line IV-IV of FIG. 1.

FIG. 5 is a cross-sectional view of one example of a cable used in the invention.

FIG. 6 is an exploded view showing one conventional connector.

FIG. 7 is an exploded view showing another conventional connector.

### DETAILED DESCRIPTION OF PREFERRED EMBODIMENTS

A preferred embodiment of a connector of the present invention will now be described in detail with reference to the drawings.

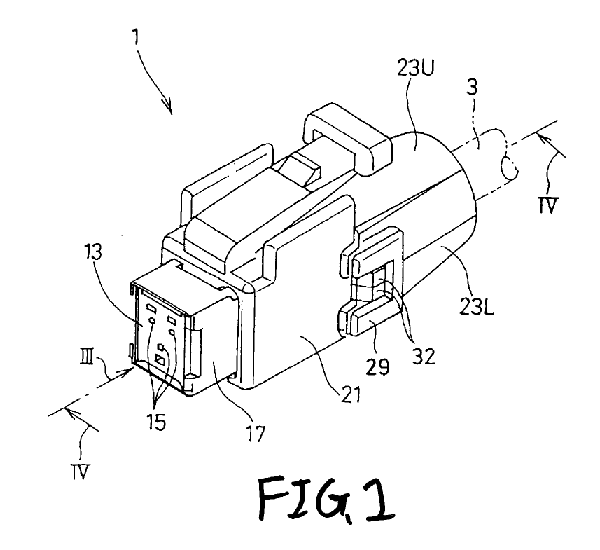

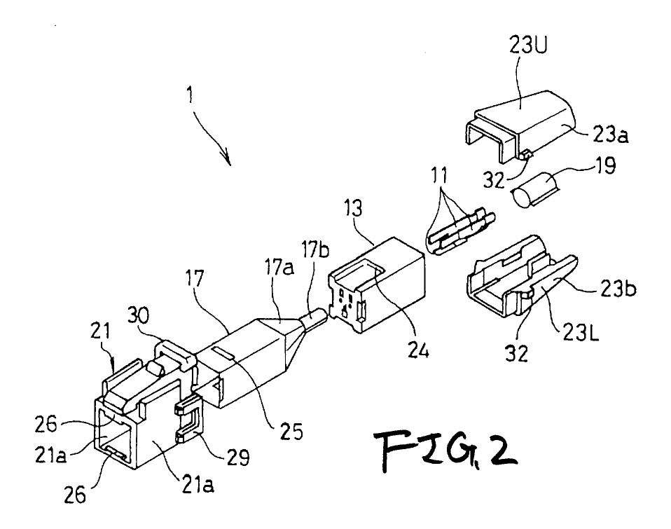

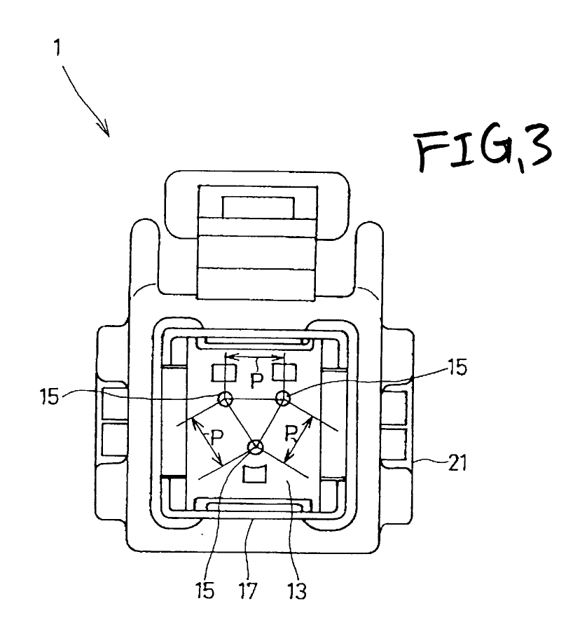

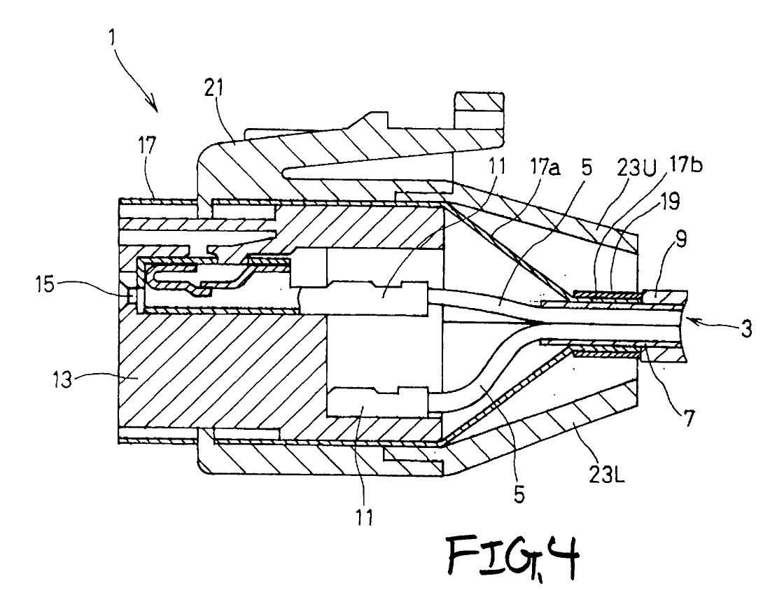

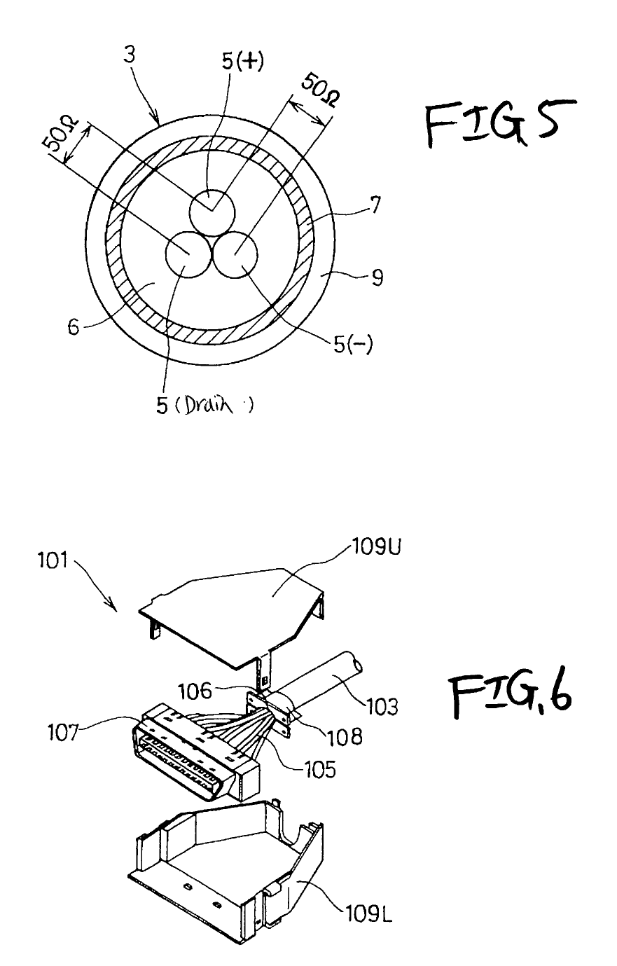

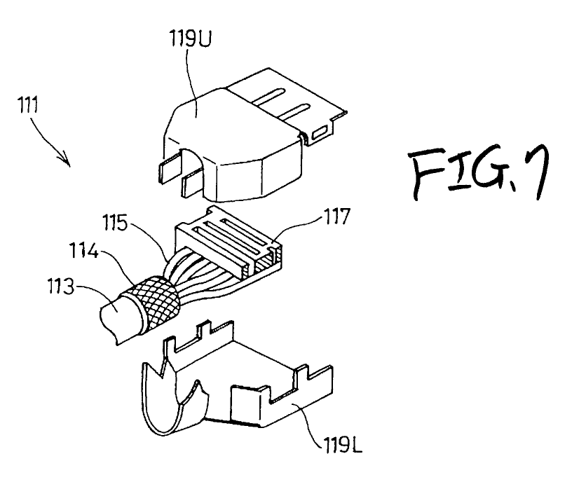

FIG. 1 is a perspective view showing the appearance of one preferred embodiment of the connector according to the invention, FIG. 2 is an exploded, perspective view of the connector of FIG. 1, FIG. 3 is a front-elevational view of the connector, and FIG. 4 is across-sectional view of the connector. FIG. 5 is a cross-sectional view of a cable used in the connector of the invention.

The cable, used in the connector of the invention, is suited for flowing differential signals therethrough so as to transmit a digital high-definition image signal or to connect buses between equipments.

One example of such cable 3, shown in FIG. 5, comprises: a set of (three) wires 5 (a pair of signal wires (+, −) and a drain wire) bundled together; an inner sheath 6, covering the three wires 5 in such a manner that these wires 5 are arranged to assume a generally round cross-sectional shape; a shielding conductor (braid) 7 covering the inner sheath; and an insulating outer sheath 9 covering the shielding conductor. The three wires 5 feed the differential signals, and therefore the impedance is, for example, 100 Ω (50 Ω and 50Ω). This impedance can be adjusted by the distance between the three wires and the cross-sectional area of the wires.

Next, the connector of this embodiment will be described with reference to FIG. 2 which is an exploded, perspective view thereof.

As shown in FIG. 2, this connector 1 comprises: an inner housing 13 for receiving connection terminals 11; a shell terminal 17 mounted on the inner housing 13 to cover an outer peripheral surface thereof; an outer housing 21, in which the inner housing 13 and the shell terminal 17 are fitted; a sleeve 19 for holding the shell terminal 17 in contact with the shielding conductor 7 (see FIG. 5) exposed at the distal end portion of the cable 3 to be connected to the terminals; and upper and lower rear holders 23U and 23L connected to the outer housing 21 to cover a rear end portion of the shell terminal 17 projecting outwardly from the outer housing 21.

As shown in FIG. 4, the connection terminals 11 are fastened by pressing to end portions of the respective wires 5, exposed at the distal end portion of the cable 3 by removing the insulating outer sheath 9, so that the cable 3 can be connected to an electronic equipment or the like.

Three terminal receiving chambers 15 (corresponding in number to the connection terminals 11) for respectively receiving the connection terminals 11 are formed within the inner housing 13.

The terminal receiving chambers 15 are so arranged that the connection terminals 11, connected respectively to the end portions of the three wires 5, can be arranged in a triangular form, analogous to the form of arrangement of the three wires 5, in order to achieve the impedance matching in the connector 1. Namely, originally, the inner housing 13 is of such a construction that the adjacent wires 5, as well as the adjacent connection terminals 11, are spaced from one another, which tends to invite the impedance mismatching. Therefore, in order to achieve the impedance matching in the inner housing 13, the terminal receiving chambers 15 are spaced a predetermined distance P from one another as shown in FIG. 3, and are arranged in a triangular form analogous to the initial form of arrangement of the three wires 5, and each connection terminal 11, connected to the wire, is received in the corresponding terminal receiving chamber 15 disposed nearest to it. As mentioned above, the terminal receiving chambers 15 are provided such that the arrangement of the terminals of the connector 1 is analogous to the form of arrangement of the three wires 5, so that the separation of the wires 5 can be reduced, and the impedance mismatching, caused by the raveling and spreading of the wires as described above in the related art, can be kept to a minimum.

As described above, the wires 5 are connected by press-fastening to the connection terminals 11, respectively. The reason for this is as follows.

Namely, for connecting the connection terminals 11 to the respective wires 5, it is necessary to ravel the wires 3 of the cable 3. Therefore, there is a fear that the impedance increases, so that the mismatching occurs between the connector 1 and the cable 3. Therefore, preferably, the connection terminal 11 is secured to the wire 5 in such a manner that the length of the area of connection between the connection terminal 11 and the wire 5 is kept to not larger than 5 mm, and by doing so, the attenuation can be suppressed even if the impedance mismatching occurs. However, it is difficult to effect the end processing (including the removal of the insulating outer sheath 9 and inner sheath 6 and the exposure of the shielding conductor 7 at the distal end portion of the cable 1) and the soldering of the connection terminals 11 as in the conventional technique, while keeping the above connection area to within 5 mm, and besides this increases the production cost. Therefore, each wire 5 is secured to the corresponding connection terminal 11 not by soldering (which requires the increased connection length) but by the press-fastening connection. The processing of the distal end portion of each wire 5, which is required for securing the connection terminal 11 to the wire, is carried out in the same manner as in the conventional connector.

The other construction will be described, and the shell terminal 17 is formed into a square tubular shape, and covers the outer peripheral surface of the inner housing 13. Namely, the inner housing 13 is inserted into the shell terminal 17 through the rear end thereof (from a right-hand direction in FIG. 2), so that the outer peripheral surface of the inner housing 13 is covered with the shell terminal 17.

The length of the shell terminal 17 is larger than the length of the inner housing 13 in the inserting direction, and the rear end portion of this shell terminal has a tapering portion 17a of a truncated pyramid-shape, and a smaller tubular portion 17b extending from this tapering portion. The tapering portion 17a, as well as the smaller tubular portion 17b, are divided into upper and lower sections to provide a lid structure which can be opened and closed.

When the lid portions 17a and 17b of the shell terminal 17 are closed, the shell terminal 17 covers the distal end portion of the cable 3 extending outwardly from the rear end of the inner housing 13, and the smaller tubular portion 17b is fitted on the shielding conductor 7, exposed by removing the insulating outer sheath 9, and is contacted with this shielding conductor 7, thereby achieving the electrical connection therebetween, as shown in FIG. 4.

The sleeve 19 is fitted on the smaller tubular portion 17b to prevent the lid portions 17a and 17b from being opened.

The outer housing 21 has a square tubular shape, and is fitted on the inner housing 13 and the shell terminal 17. This outer housing includes a front opening 21a. The inner housing 13 and the shell terminal 17 are projected a predetermined amount from this front opening 21a toward a mating connector (not shown) Retaining claws 26 are formed at upper and lower edges of the front opening 21a, respectively. These retaining claws 26 are engaged respectively in engagement holes 24 in the inner housing 13, and also are engaged respectively in engagement holes 25 in the shell terminal 17, thereby positioning the inner housing 13 and the shell terminal 17.

Engagement frames 29 for retaining the upper and lower rear holders 23U and 23L (described later) are formed on right and left side walls 21b of the outer housing 21, respectively. A lock arm 30 for connection to the mating connector (not shown) is formed on an upper surface of the outer housing 21.

The upper and lower rear holders 23U and 23L comprise two half parts, and are combined together to cover the shell terminal 17 exposed at the rear end of the outer housing 21.

As shown in FIG. 4, a front end portion of each of the upper and lower rear holders 23U and 23L has a reduced thickness, and is fitted into the outer housing 21. Retaining projections 32, formed respectively on opposite side walls 23a, 23b of each rear holder, are engaged with and retained by the engagement frames 29 of the outer housing, so that each rear holder is connected to the outer housing 21 in a unitary manner.

For assembling the connector 1 of the above construction, first, the inner housing 13 is inserted into the shell terminal 17 through the rear end thereof. Then, the connection terminals 11, press-fastened respectively to the wires 5, are inserted respectively into the terminal receiving chambers 15 in the inner housing 13. In this condition, the lid portions 17a and 17b of the shell terminal 17 are closed, and the smaller tubular portion 17b is fitted on the shielding conductor 17 to be contacted therewith, and then the sleeve 19 is fitted on the smaller tubular portion 17b, and is fastened there to by pressing, thereby ensuring the electrical connection between the shell terminal 17 and the shielding conductor 17. Thereafter, the shell terminal 17, having the inner housing 13 fitted therein, is inserted into the outer housing 21, and then the upper and lower rear holders 23U and 23L are fitted on the outer housing 21. In the above assembling procedure, the inner housing 13, having the connection terminals 11 before hand mounted therein, can be inserted into the shell terminal 17.

As described above, in the connector according to this embodiment, the connection terminals 11 are arranged in the triangular form analogous to the initial condition of the cable 3, and with this arrangement the length of connection of the raveled wires to the respective terminals can be made shorter as compared with the conventional connector, and therefore the impedance mismatching in the connector 1 can be suppressed, thereby reducing the current loss.

And besides, the wires 5 are connected to the respective connection terminals 11 by press-fastening, and therefore the terminal-exchanging operation can be carried out more easily as compared with the soldering connection and the press-contacting connection.

Furthermore, the shell terminal 17 has the lid portions 17a and 17b which cover the rear end of the inner housing, and therefore external noises can be positively shut off.

In the above embodiment of the invention, although the cable 3 contains one set of (three) wires 5 therein, the invention can be applied also to the case where the number of the wires 5 is 6, 9, . . . Namely, the connector 1 is provided for each set of (three) wires, and the plurality of connectors are arranged in a suitable form so as to meet the requirement.

As described above, in the connector of the present invention, the connection terminals, which are secured respectively to the end portions of the wires, and are disposed within the connector, are arranged in the triangular form analogous to the initial condition of the cable, and with this arrangement the impedance matching in the connector can be achieved.

What is claimed is:

1. A connector comprising:
connection terminals to which a cable including a wire group having three wires arranged in a triangular form is connected, the connection terminals are secured to end portions of the wires, respectively, wherein the connection terminals are arranged in a triangular form, analogous to a form of arrangement of the three wires in order to achieve the impedance matching between the connector and the cable.

2. The connector according to claim 1, wherein-each of the connection terminals arranged in the triangular form is secured to the end portion of the corresponding one of the three wires disposed nearest to it.

3. The connector according to claim 1, wherein the connector includes:
an inner housing for receiving the connection terminals connected respectively to the wires by press-fastening;
an shell terminal mounted on the inner housing to cover an outer peripheral surface of the inner housing;
an outer housing in which the inner housing and the shell terminal are fitted;
a sleeve for holding the shell terminal in contact with a shielding conductor of the cable exposed at a distal end portion of the cable to be connected to the connection terminals; and
a rear holder connected to the outer housing to cover a rear end portion of the shell terminal projecting outwardly from the outer housing.

4. The connector according to claim 3, wherein
the rear end portion of the shell terminal is formed into a lid structure which can be opened and closed,
when the lid structure is in an open condition, the inner housing can be inserted into the shell terminal, and
when the lid structure is in a closed condition, the shell terminal is held in contact with the shielding conductor in surrounding relation to a rear end portion of the inner housing.
